(19) United States
(12) Patent Application Publication
(10) Pub. No.: US 2017/0090857 A1
(43) Pub. Date: Mar. 30, 2017

(54) SYSTEM AND METHOD FOR PROCESSING SIGNALS REPRESENTATIVE OF A BIOLOGICAL INFORMATION

(71) Applicant: UNIVERSITE GRENOBLE 1 JOSEPH FOURIER, SAINT MARTIN D'HERES (FR)

(72) Inventors: Jacques DEMONGEOT, Sassenage (FR); Elie-Paul COHEN, Paris (FR); Nicolas VUILLERME, Saint Martin d'Heres (FR)

(21) Appl. No.: 14/864,029

(22) Filed: Sep. 24, 2015

(51) Int. Cl. G06F 3/16; G06F 17/13; G06F 17/14

(52) U.S. Cl. CPC G06F 3/165; G06F 17/14; G06F 17/13; G10H 2250/215

(57) ABSTRACT

The invention relates to a method of processing a biological signal including peaks, said biological signal being recorded by at least one sensor, the method comprising:
extracting a peak from the biological signal,
processing the peak with a mathematical transform in order to model the peak as a solution to a differential equation,
converting the model of the peak into a sound,
repeating the extracting, processing and converting steps for a plurality of peaks of the biological signal so as to obtain a plurality of sounds, each sound corresponding to a respective peak,
generating a melody including the plurality of sounds.

### FIELD OF THE INVENTION

The present invention relates to a method of processing signals representative of a biological information in order to allow their efficient medical use by clinicians.

More precisely, it relates to a method of compressing and displaying (i.e. presenting) data contained in signals recorded by sensors, said signals bearing information about biological features.

The signals may be for instance:
Mass spectrometry signals representative of proteins,
Nuclear Magnetic Resonance (NMR) signals representative of proteins,
ElectroEncephaloGraphic (EEG) signals representative of various cerebral electric phenomena,
ElectroCardioGram (ECG) signals representative of various muscular electric phenomena,
etc.

### BACKGROUND OF THE INVENTION

Today, more and more biological information can be recorded using sensors, such as:
electro-physiologic signal sensors like ECG, arterial pulse sensors, etc., or
molecular devices like mass or NMR spectrometry, etc.

The signals obtained from such sensors can help in the establishment of a diagnostic, or can be used for therapeutic monitoring.

However, the quantity of recorded signals is so important (for instance the production of protein-DNA data is of the order of one Gigabit per patient) that the data contained in said signals have to be modelled and compressed in order to allow their efficient medical use by clinicians.

It is known to use compression methods based on Fourier technic, or wavelet transforms in order to compress data contained in signals representative of biological information. These method gives good results concerning the compression rate.

However, such compression methods are not efficient for compressing recorded signal that are not periodic in time and/or in space.

Moreover, such compression methods bring no information about the interactions between elements of the living system producing the processed signal.

An object of the present invention is to propose a method for processing biological signals which overcomes at least one of the drawbacks of the aforementioned compression methods.

### SUMMARY OF THE INVENTION

The present invention overcomes the drawbacks of previously-known methods by providing a method of processing a biological signal including peaks, said biological signal being recorded by at least one sensor, the method comprising:
extracting a peak from the biological signal,
processing the peak with a mathematical transform in order to model the peak as a solution to a differential equation,
converting the model of the peak into a sound,
repeating the extracting, processing and converting steps for a plurality of peaks of the biological signal so as to obtain a plurality of sounds, each sound corresponding to a respective peak,
generating a melody including the plurality of sounds.

The biological signal to be processed may be:
a signal representative of proteins, such as a mass spectrometry signal or a Nuclear Magnetic Resonance (NMR) signal recorded by NMR sensors,
a signal representative of various cerebral electric phenomena such as an ElectroEncephaloGraphic (EEG) signal recorded by EEG sensors,
a signal representative of various muscular electric phenomena such as an ElectroCardioGram (ECG) signal recorded by ECG sensors,
or any signal representative of a biologic feature, or of a biologic phenomenon, etc.

Preferred but non-limiting aspects of the device according to the invention are the following:
the processing step comprises processing each peak with a Dynalet transform in order to model each peak as a solution to Liénard differential equation of the following type:

d²x/dt²−Q(x)dx/dt+R(x)x=0;
the model of each peak is computed using potential-Hamiltonian decomposition;
the differential equation comprises Van der Pol equation of the following type:

d²x/dt²−μ(1−x²/b²)dx/dt+ω²x=0;
the processing step comprises the substeps consisting in:
   determining parameters “μ” and “ω” such that a period of a van der Pol limit-cycle equals a mean period of the peak,
   determining parameter “b” such that a first point of the van der Pol limit cycle identified superimpose a first point of the peak;
the converting step comprises converting the model of the peak into a sound having a variable pitch and a variable intensity during the beat of the sound.

The invention also relates to a system of processing a biological signal of processing a biological signal including peaks, said biological signal being recorded by at least one sensor, the system comprising a processor configured to:
extract a peak from the biological signal and for each peak,
process the peak with a mathematical transform in order to model the peak as a solution to a differential equation,
convert the model of the peak into a sound,
repeat the extracting, processing and converting steps for a plurality of peaks of the biological signal so as to obtain a plurality of sounds, each sound corresponding to a respective peak, and to
generate a melody including the plurality of sounds.

The invention also relates to a program for implementing in a computer a method of processing a biological signal including peaks, said biological signal being recorded by at least one sensor, the method comprising:
extracting a peak from the biological signal,
processing the peak with a mathematical transform in order to model the peak as a solution to a differential equation,
converting the model of the peak into a sound,
repeating the extracting, processing and converting steps for a plurality of peaks of the biological signal so as to obtain a plurality of sounds, each sound corresponding to a respective peak,
generating a melody including the plurality of sounds.

### BRIEF DESCRIPTION OF THE DRAWINGS

Other advantages and features will become better apparent from the following description given as non-limiting example, and from the appended drawings wherein:

FIG. 1 depicts the steps of a method of processing a biological signal,

FIG. 2 is a perspective view of a system of processing a biological signal

### DETAILED DESCRIPTION OF THE INVENTION

### 1. Principle of the System and Method According to the Invention

The method and system according to the present invention will now be described in reference to the figures. In these different Figures, the equivalent elements bear the same reference numerals.

### 1.1. Method of Processing a Biological Signal

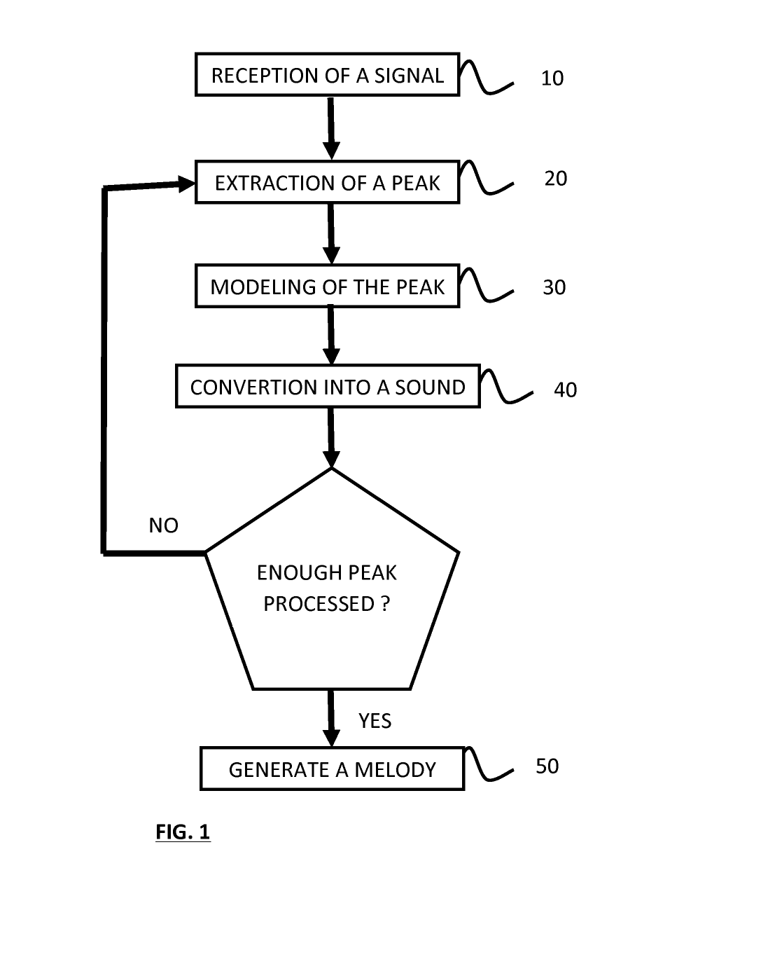

Referring to FIG. 1, an embodiment of the method according to the invention is illustrated. This embodiment will be described with regard to a biological signal corresponding to an Original protein NMR spectroscopy signal.

After the reception (step 10) of the Original protein NMR spectroscopy signal recorded by NMR sensors, a peak is extracted (step 20) from the Original protein NMR spectroscopy signal.

The extracted peak is processed in order to model the peak as a solution to a differential equation. More particularly, the method comprises modelling (step 30) the extracted peak as a solution to a van der Pol differential equation.

Indeed, the extracted peak may be modelled mathematically by a second-order differential equation of the van der Pol type of the following type:

d²x/dt²−μ(1−x²/b²)dx/dt+ω²x=0,

where b, ω and μ are three degrees of freedom of the van der Pol equation.

The expression “degree of Freedom” refers to a condition in which more than one possible solution can be reached to the second-order differential equation.

The modelling step consists in finding a van der Pol limit cycle that fits to the extracted peak of the Original protein NMR spectroscopy signal. This is done by achieving an iterative transformation approach that generates new potentials (known as Hamiltonians) from older potentials by incrementally removing degrees of freedom during each iteration.

The processing step allows obtaining a model of the extracted peak. This model is converted into a musical sound defined by:
a “beat” corresponding to the delay (i.e. unit of time) of the musical sound,
a “pitch” corresponding to the vibration frequency of the musical sound, and
an “intensity” corresponding to the strength (which is dependent from the vibratory energy) of the musical sound.

Advantageously, musical sound obtained by converting the model of the peak is not harmonic, so that said musical sound has a variable pitch and a variable intensity during its beat. Each sound is thus representative of a respective protein, and bears information about said protein.

After having converted a plurality of modelled peaks into respective sounds, it is possible to generate a melody including said musical sounds (step 50) and presenting the result to a user.

The above disclosed method allows processing biological signals and synthesizing sounds in order to facilitate their use in a diagnostic process.

The most immediate application is the sound quality ECG type of physiological signals, EEG and pulse and the spectrograms (mass or NMR) of proteins and/or nucleic acids.

In the preceding description, the method was described in reference of the van der Pol equation. The skilled person will understand that the above method is not limited to the resolution of a Van der Pol equation, and that other type of Liénard systems can be used for the modelling step 30, such as the FitzHugh-Nagumo equation.

The method described above may be applied in a processing system comprising a processing unit for executing the different steps of the method.

The processing unit is for example a computer(s), a processor(s), a microcontroller(s), a microcomputer(s), a programmable automaton(a), a specific application integrated circuit(s), other programmable circuits, or other devices which include a computer such as workstation.

The processing unit is coupled with a memory(ies) which may be integrated to or separated from the processing unit. The memory may be a ROM/RAM memory of the computer, a CD-ROM, a USB stick, a memory of a central server. This memory may allow the storage:
of the original biological signal, the modeled peaks, the musical sounds synthesized with the modeled peaks or further
the processing method applied by the processing unit.

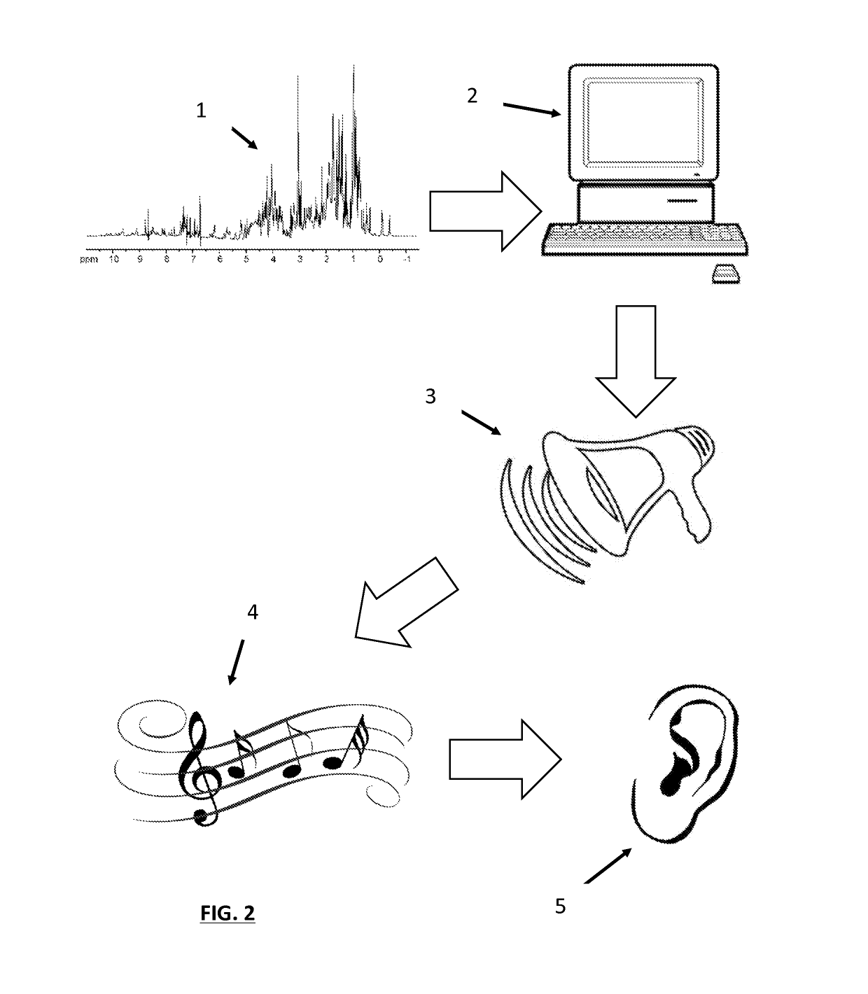

Referring to FIG. 2, a system for implementing the above mentioned method is illustrated. The system includes a computer 2 comprising a processor adapted for executing the steps of the method illustrated on FIG. 1.

When the computer 2 receives a biological signal 1, its processor extracts different peaks from the biological signal 1.

For each peak, the processor determines a peak model corresponding to a solution of a Liénard system, and converts said peak model into a respective musical sound. More particularly, each peak model is converted into a respective electrical audio signal.

A plurality of musical sounds representative of the different peaks are thus obtained. The plurality of musical sounds constitutes a melody 4 that is played on speakers 3 of the computer 2.

The melody 4 thus obtained can be heard by a user 5 in order to assist the user in the diagnosing of a pathology.

### 2. Annex

With the present annex, the method and system described above may be better understood. Certain notations used earlier may possibly differ in the following.

### 2.1. Introduction

The goal of spectral density estimation is to estimate the spectral density of a random signal from a sequence of time samples of the signal. Intuitively speaking, the spectral density characterizes the frequency content of the signal.

Spectral density estimation is usually done using Fourier transform or wavelet transform. In the following, a new transform called “Dynalet” based on Liénard differential equations will be disclosed. Dyanlet transform allows modelling the mechanism that is the source of the signal.

In Sections 2, the classical Fourier and wavelet transforms will be described. Then in Section 3, the prototype of the Lienard equations that is the van der Pol equation will be described. In Section 4, the Dynalet transform will be defined, and in Sections 5 to 8, different biological applications using the Dynalet Transform will be discussed.

### 2.2. Fourier and Wavelet Transforms

The Fourier transform comes from the aim by Fourier to represent in a simple way functions used in physics, notably in the heat propagation modelling.

He used a base of functions made of the solutions of the simple not damped pendulum differential equation (cf. a trajectory in FIG. 1):

dx/dt=y, dy/dt=−ω²x,

whose general solution is:

x(t)=k cos ωt, y(t)=−kω sin ωt.

By using the polar coordinates θ and ρ defined from the variables x and z=y/ω, we get the new differential system:

dθ/dt=ω, dρ/dt=0,

with θ=Arctg(z/x) and ρ²=x²+z².

The polar system is conservative, its Hamiltonian function being defined by:

H(θ,ρ)=ωρ

The general solution x(t)=k cos ωt, z(t)=k sin ωt has two degrees of freedom, k and ω, respectively the amplitude and the frequency of the signal, and constitutes an orthogonal base, by choosing for ω the multiples (called harmonics) of a fundamental frequency ω₀.

Concerning the wavelet transform, Haley used in 1997 a simple wavelet transform for representing signals in astrophysics. He used a base of functions made of the solutions of the damped pendulum differential equation:

dx/dt=y, dy/dt=−(ω²+τ²)x−2τy,

whose general solution is:

x(t)=ke⁻^{_{τ}}^{t} cos ωt, y(t)=−ke⁻^{_{τ}}^{t}(ω sin ωt+τ cos ωt).

By using the polar coordinates θ and ρ defined from the variables x and z=−y/ω−τx/ω, we get the differential system:

dθ/dt=ω, dρ/dt=−τρ.

The polar system is dissipative (or gradient), its potential function being defined by:

P(θ,ρ)=−ωθ+τρ²/2.

The general solution x(t)=k e⁻^{_{τ}}^{t} cos ωt, z(t)=k e⁻^{_{τ}}^{t} sin ωt has three degrees of freedom, k, ω and τ, the last parameter being the exponential time constant responsible of the pendulum damping.

### 2.3. The Van Der Pol System

For the Dynalet transform, we propose to use a base of functions made of the solutions of the relaxation pendulum differential equation (van der Pol system), which is a particular example of the most general Liénard differential equation:

dx/dt=y, dy/dt=−R(x)x+Q(x)y,

which is specified in van der Pol case by choosing:

R(x)=ω², and Q(x)=μ(1−x²/b²).

Its general solution is not algebraic, but can be approximated by a family of polynomials.

The van der Pol system is a potential-Hamiltonian system, defined by the potential P_{vdP} and Hamiltonian H_{vdP} functions, H_{vdP} being for example approximated at order 4, when ω=b=1, by:

H_{vdP}(x,y)=(x²+y²)/2−μxy/2+μyx³/8−μxy³/8,

which allows to obtain the equation of its limit-cycle:

H_{vdP}(x,y)≈2.024.

The van der Pol system has three degrees of freedom, b, ω and μ, the last an-harmonic parameter being responsible of the asymptotic stability of pendulum limit-cycle, symmetrical with respect to the origin, but not revolution symmetrical. These parameters receive different interpretations:
μ appears as an an-harmonic term: when μ=0, the equation is that of the simple pendulum, i.e., a sine wave oscillator, whose amplitude depends on initial conditions; Relaxation oscillations are observed even with small initial conditions, with a period T equal to 2π/Imβ near the bifurcation value μ=0, where B is eigenvalue of the Jacobian matrix J of the van der Pol equation at the origin:

$$J = ( \begin{matrix}0 & 1 \\ - {ω}^{2} & μ\end{matrix} )$$

The characteristic polynomial of J is equal to:

β²×μβ+ω²=0,

hence:

β=(μ±(μ²−4ω²)^{1/2})/2 and T≈2π/ω+πμ²/4ω³.
b looks as a term of control: when x>b and y>0, the derivative of y is negative, acting as a moderator on the velocity. The maximum of the oscillations amplitude is about 2b, whatever initial conditions and values of the other parameters. More precisely, the amplitude aₓ(μ) of x is estimated by 2b<aₓ(μ)<2.024b, for every μ>0, and when g is small, aₓ(μ) is estimated by: aₓ(μ)≈(2+μ²/6)b/(1+7μ²/96) [12,13]. Half-amplitude a_{y}(μ) of y is obtained for dy/dt=0, i.e., approximately for x=b (if ω is small), then a_{y}(μ) is the dominant root of the following algebraic equation: H_{vdP}(b,a_{y}(μ)=2.024.
ω is a frequency parameter, when μ is small and the period is then about 2π/ω. When μ>>1, the period T of the limit cycle is determined mainly by the time during which the system stays around the states where y is O(1/μ), T being roughly estimated to be T≈2π/ω, and the system can be rewritten as:

dχ/dt=ζ, dζ/dt=−ω²χ+μ(1−χ²/μ²)ζ≈−ω²χ+μζ,

with the change of variables:
χ=μx/b, ζ=μy/b.

### 2.4. The Dynalet Transform

The Dynalet transform consists in identifying a Liénard system based on the interactions mechanisms between its variables (well expressed by its Jacobian matrix) analogue to those of the experimentally studied system, whose limit cycle is the nearest (in the sense of the Δ set or the mean quadratic distances between sets of van der Pol points and experimental points having the same phase, sampled respectively from the original signal and van der Pol limit cycle) to the signal in the phase plane (xOy), where y=dx/dt.

For example, the Jacobian interaction graph of the van der Pol system contains a couple of positive and negative tangent circuits.

Practically, for performing the Dynalet transform it is necessary to choose:
i) the parameters ρ and ω such that the period of the van der Pol limit cycle equals the mean period of the original signal,
ii) an abscissa translation of the origin of axes (corresponding to parameter b), in order to fix the first van der Pol point on its limit cycle identified, by convention, to the first signal point (corresponding to the mean baseline value of the original signal), then
iii) a homothety on these axes defining their scales, by minimizing the distance between two sets of points from both van der Pol and original signals.

By repeating this process for the difference between the original signal and the van der Pol limit cycle, it is possible to get successively a polynomial approximation of the fundamental reconstructed signal and its harmonics.

The potential and Hamiltonian parts P_{vdP} and H_{vdP} used for this transform can be calculated using technics known from the skilled person. For example, for μ=1 (resp. μ=2), the corresponding polynomials are respectively P₁ and H₁ (P₂ and H₂) defined by:

P₁(x,y)=−3x²/4+y²/4+3x⁴/32+y⁴/96−x²y²/16 and H₁(x,y)=(x²+y²)/2−3xy/2+3yx³/8−y³x/24−2

(resp. P₂(x,y)=−3x²/4+y²/4+3x⁴/32+y⁴/96−x²y²/16 and H₂(x,y)=(x²±y²)/2−3xy/8+3yx³/8−y³x/24−½).

Using this potential-Hamiltonian decomposition, it is possible to calculate an approximate solution S(kᵢ,μᵢ)(t) of the van der Pol differential system corresponding to the i^{th} harmonics of the Dynalet transform, as a polynomial of order 2+i verifying:

dx/dt=y and dy/dt=−x+μᵢ(1−kᵢ²x²)y

We will search for example for the approximate solution x(t)=S(1,1)(t) as a polynomial of order 3 in the case μ=1:

x(t)=c₀+c₁t+c₂t²+c₃t³, y(t)=c₁+2c₂t+3c₃t²

The polynomial coefficients cᵢ's above represent both the potential and Hamiltonian parts of the van der Pol system and they can be obtained by identification with P₁ and H₁ derivatives:

dx/dt=−∂P₁/∂x+∂H₁/∂y, dy/dt=−∂P₁/∂y−∂H₁/∂x.

Then, we get:

c₀²/2+c₁²/2−3c₀c₁/2+3c₀³c₁/8−c₀c₁³/24=2,

c₂c₃−9c₃²/2−9c₀c₂³+9c₀c₂³/4+27c₀²c₃²/8−3c₀c₂c₃²/4−c₂⁴/24=0

[symbol]

c₂c₃−27c₂³/2+9c₃²−3c₂c₃²/2−c₂⁴/24=0,

which implies:
c₀=2, c₁=0, c₂≈0.46 and c₃≈0.04.

Because of the symmetry of the limit cycle, all the solutions {S(kⱼ,μ/2^{j})}_{jεIN} are orthogonal and we can decompose any continuous function f on this base, thanks to the Weierstrass theorem.

### 2.5. Cardio-Vascular Applications

We propose to apply this new technique to real signals like ECG and pulse rhythm. In these both cases, the rhythmic cardiovascular activity results from the summation of cellular oscillators located in the cardiac sinus node, which are subject to the control of the bulbar cardiovascular moderator and cardio-accelerator centres, which modulate the sinus signal, integrating the influence of the inspiratory bulbar centre, which causes the appearance of harmonics in the cellular rhythm.

The Dynalet transform consists in identifying a Liénard system which expresses interactions between its variables through its Jacobian matrix analogue to those of the experimentally studied system, whose limit cycle is the nearest (in the sense of the distance Δ between sets, or of the mean quadratic distance between points of same phase) to the signal pattern in the phase plane (xOy), where y=dx/dt.

Practically, if the Liénard system is a van der Pol system, it is necessary to execute the following transforms for getting Dynalet approximation from original signal:
i) estimate the parameter p and w, such that the period of the van der Pol signal be equal to the mean empirical period (calculated for the original signal) and
ii) do a translation of the abscissa of the origin of axes in the phase plane, then
iii) do a homothetic change of the abscissa, in order to match the van der Pol signal to the original signal.

Then the whole approximation procedure done for the ECG signal involves the following steps:
a. suppress the time intervals where the signal was under the critical plateau value Λ of the Levy time λ(ε) equal to the duration the signal has passed between 0 and ε. This step allows obtaining the QRS complex of the experimental ECG,
b. fix the value of the parameter μ such as the period of the van der Pol signal be equal to the QRS complex duration,
c. perform a translation of the abscissa of the origin of the (xOy) phase plane and a scaling on the x axis of the van der Pol signal, so as to adjust them to the maximum of x QRS complex,
d. finish the approximation with an parameter optimization (parameters ω and b), by matching the QRS complex points to the van der Pol limit-cycle in order to minimize the Δ distance between the interiors of the QRS points set and the van der Pol limit-cycle (denoted respectively ECG and VDP, with interiors ECG₀ and VDP₀) in the phase plane:

Δ(ECG₀,VDP₀)=Area[(ECG₀\VDP₀)∪(VDP₀\ECG₀)],
by using a Monte-Carlo method for estimating the area of the interiors of the linear approximation of empirical points of the Experimental QRS complex and of the Van der Pol limit-cycle, calculated from a sample of points in the phase plane, respectively {Eᵢ}_{i=1,100} and {Pᵢ}_{i=1,100}. It is also possible to minimize the mean quadratic distance between the points of the van der Pol limit cycle and empirical points having the same phase,
e. repeat the procedure for obtaining the successive harmonics in order to respect for example a fixed threshold of 20 dB for the signal-to-noise rate SNR and 10% for the quadratic relative error QRE,
f. calculate a polynomial approximation of the signal from the quadratic estimate of the van der Pol limit cycle corresponding to the step “e”, e.g., if ω=b=1:

H_{vdP}(x,y)=(x²+y²)/2−μxy/2+μyx³/8−μxy³/8=2.024

### 2.6. Application to ECG

Let now compare the performance of the Dynalet reconstruction of the ECG signal with a Fourier transform having the same number of parameters, that is 5, i.e., the origin abscissa translation, two values of μ (period) and two abscissa scaling ratios for the fundamental and first harmonic of the Dynalet transform; the period, the origin abscissa translation and three values of sine coefficients for the Fourier transform F(x), whose equation is:

F(x)=0.42142 cos(2πx/176)+0.40773 sin(2πx/176)+0.34225−0.10539 cos(4πx/176).

For defining a quantitative assessment of the error between abscissæ of the K original signal observations Xᵢ's (obtained after extraction of the baseline) and their Fourier or Dynalet approximations we use the notions of Mean Square Error (MSE_{X}) and Signal to Noise Ratio (SNR_{X}) where:

MSE_{X}=Σ_{i=1,K}(Xᵢ−ξᵢ)²/Σ_{i=1,K}Xᵢ², SNR_{X}=−10 Log₁₀ MSE_{X}

The calculation made for the QRS signal shows a good Dynalet fit for ordinates values:
SNR_{Y Dynalet}=40 dB, SNR_{Y Fourier}=15.7 dB, MSE_{Y Dynalet}=27 10⁻⁵, MSE_{Y Fourier}=22 10⁻⁴

In the Fourier reconstitution, QRE_{X Fourier}=0.08, SNR_{X Fourier}=22 dB and QRE_{X Dynalet}=0.09, SNR_{X Dynalet}=21 dB.

We can notice that this Fourier transform needs six parameters (including the value of the period), while the Dynalet transform requires only five parameters.

Biological rhythms other than the ECG or pulse can be interpreted and compressed using Liénard equations and the Dynalet transform, like the respiratory rhythm or the single cardiac cell activity, which represent a good example of relaxation wave, as well as pulse activity. In summary, the main advantages of the Dynalet transform on the Fourier transform in the case of periodic physiologic signals are:
the limit-cycles of the Liénard systems like those of the van der Pol system, are asymptotically stable, unlike those of the simple pendulum of Fourier transform, which are asymptotically unstable because the simple pendulum is a conservative Hamiltonian system. In both cases, these trajectories have algebraic approximations,
the approximating system in the case of the Dynalet transform explains the mechanism genesis of the signal; for example, in the case of the heart, the van der Pol system has the same interaction structure as the cardiac system,
the trajectories of the Dynalets can break the rotation symmetry of the simple pendulum, which makes them more likely to approximate the asymmetrical biological waves, like the relaxation waves.

### 2.7. Non-Periodic Protein Spectrum Signal

In addition to the compression of periodic signals, another application of the Dynalet transform is compressing a non-periodic signal.

For example, the Dynalet transform can be used in order to approximate the spectrum of a protein. More generally, it is possible to apply the Dynalet transform to each peak of a protein NMR spectroscopy signal or of a protein mass spectrometry signal.

The identification of proteins by their spectrum allows for example the construction of complex genetic control networks, such as those found in the regulation of immune system, where key proteins are effectors of the genetic expression (activators or inhibitors) and may be subject to pathologic conditions, leading to up- or down-expressions. These regulatory interactions lead to abnormal protein or protein complexes concentrations in excess or in lack, and spectroscopy peaks indicating these pathologic defects can be treated by the Dynalet approach. Of course, other alternative techniques for estimating protein spectra already exist, like kernel functional estimation tools, but there are not related to the mechanism of production of the protein signal.

The Dynalet transform applied to protein data can be considered as a real protein “stethoscope”, which would give sense to numerous metabolic data, which, although very heavy in terms of information (about 5 Go per patient in a modern hospital), are in general not queried and used by clinicians (especially in emergency) and hence remain in the big patient centred data bases, often true cemeteries full of unused data.

In the beginning of the XIXth century, R. Laennec invented the modern stethoscope and described the thoracic sounds in the Traité de l'auscultation médiate (1819), converting into a synthetic functional information for the ear what physicians were previously describing at numerous anatomic and physiologic levels with their eyes, hence creating the modern medical diagnosis based on the auscultation.

We propose to follow the same methodology, by representing the spectral information from NMR and Mass spectroscopy into signals converted in sounds, expecting that this “protein melody”, whose peaks are well enhanced by the human ear at the cochlear level, serve to differentiate pathologies from the normality and remain in the memory of the clinicians (e.g., in the context of a rapid medical decision in an emergency service or of a discussion about a complex case in a cancer staff) as quantitatively correlated and semantically associated to precise metabolic diseases, in order to compensate:
the complexity of the interactions between proteins and with their substrate and regulation molecules,
the overflow of information provided by numerous devices like NMR and mass spectroscopy.

### 2.8. Conclusion

Generalizing compression tools like Fourier or wavelets transforms is possible, if we consider that non symmetrical biological signals are often produced by relaxation mechanisms. In this case, we can propose for the dynamical systems modelling these biological signals Liénard type differential equations, like the van der Pol equation (or equivalent equation, such as the FitzHugh-Nagumo equation) classically used to model relaxation waves and, more generally, non-symmetrical biological relaxation systems often produced by mechanisms based on interactions of regulon type (i.e., possessing at least one couple of positive and negative tangent circuits inside their Jacobian interaction graph).

The corresponding new transform, called Dynalet transform, has been built in the same spirit as the wavelet transform (used for example for representing solutions of turbulent systems like Burger equation), the Hanusse transform, or the methodology proposed for estimating Tailored to the Problem Specificity Mathematical Transforms.

As for the Fourier and wavelet transforms, a fast estimation of the Lienard coefficients (calculable using potential-Hamiltonian decomposition techniques) is needed by the fast Dynalet transform and could be possible following the neural networks methodology.

Then, the Dynalet transform will be for example very useful for compressing in real-time the signals coming from e-health systems necessary to the fusion between actimetric and physiologic data recorded at home, with genetic and protein information coming in general from hospital records, in order to perform adequate personalized surveillance and trigger pertinent alarms without false alerts.

Those skilled in the art will understand that many modifications can be made to the device and method described above without materially departing from new ideas presented here.

It is therefore clear that the examples given above are only particular illustrations and in no way limiting.

As a consequence, all modifications of this type are intended to be incorporated inside the scope of the attached claims.

What is claimed:

1. A method of processing a biological signal including peaks, said biological signal being recorded by at least one sensor, the method comprising:
extracting a peak from the biological signal,
processing the peak with a mathematical transform in order to model the peak as a solution to a differential equation,
converting the model of the peak into a sound,
repeating the extracting, processing and converting steps for a plurality of peaks of the biological signal so as to obtain a plurality of sounds, each sound corresponding to a respective peak,
generating a melody including the plurality of sounds.

2. The method according to claim 1, wherein the processing step comprises processing each peak with a Dynalet transform in order to model each peak as a solution to Liénard differential equation of the following type:
d²x/dt²−Q(x)dx/dt+R(x)x=0.

3. The method according to claim 1, wherein the model of each peak is computed using potential-Hamiltonian decomposition.

4. The method according to claim 1, wherein the differential equation comprises Van der Pol equation of the following type:
d²x/dt²−μ(1−x²/b²)dx/dt+ω²x=0.

5. The method according to claim 4, wherein the processing step comprises the substeps consisting in:
determining parameters “μ” and “ω” such that a period of a van der Pol limit-cycle equals a mean period of the peak,
determining parameter “b” such that a first point of the van der Pol limit cycle identified superimpose a first point of the peak.

6. The method according to claim 1, wherein the converting step comprises converting the model of the peak into a sound having a variable pitch and a variable intensity during the beat of the sound.

7. A system of processing a biological signal including peaks, said biological signal being recorded by at least one sensor, the system comprising a processor configured to:
extract a peak from the biological signal and for each peak,
process the peak with a mathematical transform in order to model the peak as a solution to a differential equation,
convert the model of the peak into a sound,
repeat the extracting, processing and converting steps for a plurality of peaks of the biological signal so as to obtain a plurality of sounds, each sound corresponding to a respective peak, and to
generate a melody including the plurality of sounds.

8. A program for implementing in a computer a method of processing a biological signal including peaks, said biological signal being recorded by at least one sensor, the method comprising:
extracting a peak from the biological signal,
processing the peak with a mathematical transform in order to model the peak as a solution to a differential equation,
converting the model of the peak into a sound,
repeating the extracting, processing and converting steps for a plurality of peaks of the biological signal so as to obtain a plurality of sounds, each sound corresponding to a respective peak,
generating a melody including the plurality of sounds.
